(19) United States
(12) Patent Application Publication
(10) Pub. No.: US 2020/0366694 A1
(43) Pub. Date: Nov. 19, 2020

(54) METHODS AND SYSTEMS FOR MALWARE HOST CORRELATION

(71) Applicant: Lastline, Inc., Palo Alto, CA (US)

(72) Inventors: Clemens Kolbitsch, Goleta, CA (US); Roman Vasilenko, Montecito, CA (US)

(21) Appl. No.: 16/986,021

(22) Filed: Aug. 5, 2020

Related U.S. Application Data
(63) Continuation of application No. 14/947,397, filed on Nov. 20, 2015.

(51) Int. Cl. H04L 29/06

(52) U.S. Cl. CPC H04L 63/1416; H04L 63/1441

(57) ABSTRACT

Malicious network activity can be detected using methods and systems that monitor execution of code on computing nodes. The computing nodes may be network-connected nodes, may be infected with malicious code or malware, and/or may be protected by the monitor to prevent such infection or to mitigate impact of such infection. In some implementations, a monitoring system monitors execution of malicious code on an infected network node, detects an interaction between the infected network node and a remote node, and records information representative of actions taken by the malicious code subsequent to the interaction. In some implementations, the monitoring system monitors execution of suspect code on a protected computing node, records information representative of a network interaction between the protected computing node and a remote node, and detects actions taken by the suspect code consistent with the actions taken by the malicious code represented in the recorded information recorded.

### CROSS-REFERENCE TO RELATED APPLICATION

This application is a continuation application of U.S. application Ser. No. 14/947,397, titled “Methods and Systems for Malware Host Correlation,” filed on Nov. 20, 2015, which is incorporated by reference in its entirety herein.

### BACKGROUND

The present application relates generally to the field of computer security. In general, a computing device may have one or more vulnerabilities that can be leveraged by malicious code to compromise the computing device. In addition, malicious code might be introduced onto a computing device by deceiving the user. Computer security is improved through the detection of malicious software (“malware”) that uses malicious code to exploit vulnerabilities or deceives the user in order to repurpose infected computers. Once malware is detected, the deceptive behavior is identified, and/or the exploits are understood, security systems may be designed to recognize and block the malware and the vulnerabilities may be patched.

### SUMMARY

Although a host computing system infected with malware is ostensibly under the control of a first party, the malware may execute instructions selected by another party (a malicious “second” party) via commands received by the malware from a remote network node. The remote network node, referred to as a “command and control” or “C & C” node, may also be an infected node, e.g., with an owner or operator who is unaware that the remote node is being used as a command and control node. The infected host executes instructions selected by the second party responsive to receiving commands from the command and control node. The executed instructions may be identified as malicious. For example, after connecting to a C & C host, the malware might try to modify the host computing system's operating system (e.g., to disable an automatic security update feature), try to shutdown virus or spyware detection software, try to install spyware, try to send spam emails, transmit information to a data sink, and so forth. A monitoring system, as described herein, can analyze malware behavior after a network interaction to correlate the behavior with the network interaction. The monitoring system learns from the correlations and can be used to improve prevention of future malware infection.

In one aspect, the disclosure relates to a method of detecting malicious network activity. The method includes monitoring execution of malicious code on an infected network node, detecting a control interaction between the infected network node and a first remote network node, and recording in a knowledgebase information representative of one or more actions taken by the malicious code subsequent to the control interaction. The method further includes monitoring execution of suspect code on a protected network node, recording information representative of a network interaction between the protected network node and a second remote network node, and detecting one or more actions taken by the suspect code consistent with the one or more actions taken by the malicious code represented in the information recorded in the knowledge base. In some implementations, this information is recorded as a behavior model. The method then, based on detecting the one or more actions taken by the suspect code, includes one or more of classifying the protected network node as an infected network node, identifying the second remote network node as a malicious end node, adding an identifier for the second remote network node to a watch-list, recording, in the knowledge base, a traffic model based on the recorded second information representative of the second network interaction, continuing to monitor the protected network node as an infected network node, and taking remediation action to block further execution of, or to remove, the malicious code from the protected network node.

In some implementations of the method, the infected network node and the protected network node are different nodes. In some implementations of the method, the infected network node and the protected network node can be the same node. In some implementations of the method, the first remote network node and the second remote network node are different nodes. In some implementations of the method, the first remote network node and the second remote network node can be the same node. In some implementations, the first remote network node is one of: a command and control center, an exploit delivery site, a malware distribution site, a malware information sink configured to receive information stolen by malware and transmitted to the information sink, or a bot in a peer-to-peer botnet. Examples of identifiers for the second remote network node that may be used in various implementations of the watch-list include, but are not limited to, a network address, an Internet Protocol (v.4, v.6, or otherwise) address, a network domain name, a uniform resource identifier (“URI”), and a uniform resource locator (“URL”). In some implementations, recording information for the first network interaction includes sniffing packets on a network and recording a pattern satisfied by the sniffed packets. In some implementations, recording the first information representative of the one or more actions taken by the malicious code subsequent to the first network interaction includes generating a behavioral model of the one or more actions taken by the malicious code subsequent to the first network interaction and recording the behavioral model in the knowledge base.

In some implementations, the method includes maintaining a watch-list of malicious end nodes, the watch-list containing network addresses corresponding to network nodes identified as malicious. For example, the network nodes on the watch-list may be identified as one or more of: malware controllers, components of malware control infrastructure, and malware information sinks configured to receive information stolen by malware and transmitted to the information sink. In some such implementations, the method includes adding, to the watch-list, an identification including at least a network address for the second remote network node and selectively blocking the protected network node from establishing network connections with network nodes identified in the list. In some such implementations, the method includes detecting an attempt by the protected network node to establish a network connection to a remote network node identified by a network address in the watch-list and allowing the protected network node to send a network packet to the remote network node on the watch-list despite the node's representation on the watch-list. Such methods may further include determining that the network packet fails to reach the remote network node identified on the watch-list and, in response, removing identification of the remote network node from the watch-list.

In one aspect, the disclosure relates to a system that includes computer-readable memory (or memories) and one or more computing processors. The memory stores a knowledge base and a communication log. The one or more computing processors are configured to execute instructions that, when executed by a computer processor, cause the computer processor to monitor execution of malicious code on an infected network node, detect a control interaction between the infected network node and a first remote network node, and record, in the knowledge base, a behavioral model representative of one or more actions taken by the malicious code subsequent to the first network interaction. The executed instructions further cause the computer processor to monitor execution of suspect code on a protected network node, record, in the communication log, information representative of a second network interaction between the protected network node and a second remote network node, detect one or more actions taken by the suspect code consistent with the behavioral model, and based on detecting the one or more actions taken by the suspect code take one or more actions of: classifying the protected network node as an infected network node, identifying the second remote network node as a malicious end node, adding an identifier for the second remote network node to a watch-list, recording, in the knowledge base, a traffic model based on the recorded second information representative of the second network interaction, continuing to monitor the protected network node as an infected network node, and taking remediation action to block further execution of, or to remove, the malicious code from the protected network node.

In some implementations of the system, the infected network node and the protected network node are different nodes. In some implementations of the system, the infected network node and the protected network node can be the same node. In some implementations of the system, the first remote network node and the second remote network node are different nodes. In some implementations of the system, the first remote network node and the second remote network node can be the same node. In some implementations, the first remote network node is one of: a command and control center, an exploit delivery site, a malware distribution site, a malware information sink configured to receive information stolen by malware and transmitted to the information sink, or a bot in a peer-to-peer botnet. Examples of identifiers for the second remote network node that may be used in various implementations of the watch-list include, but are not limited to, a network address, an Internet Protocol (v.4, v.6, or otherwise) address, a network domain name, a uniform resource identifier (“URI”), and a uniform resource locator (“URL”). In some implementations, recording information for the first network interaction includes sniffing packets on a network and recording a pattern satisfied by the sniffed packets. In some implementations, recording the first information representative of the one or more actions taken by the malicious code subsequent to the first network interaction includes generating a behavioral model of the one or more actions taken by the malicious code subsequent to the first network interaction and recording the behavioral model in the knowledge base.

In some implementations of the system, the executed instructions further cause the computer processor to maintain a watch-list of malicious end nodes, the watch-list containing network addresses corresponding to network nodes identified as malicious. For example, the network nodes on the watch-list may be identified as one or more of: malware controllers, components of malware control infrastructure, and malware information sinks configured to receive information stolen by malware and transmitted to the information sink. In some such implementations, the executed instructions further cause the computer processor to add, to the watch-list, an identification including at least a network address for the second remote network node and selectively block the protected network node from establishing network connections with network nodes identified in the list. In some such implementations, the executed instructions further cause the computer processor to detect an attempt by the protected network node to establish a network connection to a remote network node identified by a network address in the watch-list and allow the protected network node to send a network packet to the remote network node on the watch-list despite the node's representation on the watch-list. In some such implementations, the executed instructions further cause the computer processor to determine that the network packet fails to reach the remote network node identified on the watch-list and, in response, remove identification of the remote network node from the watch-list.

In some implementations, the executable instructions for the system are stored on computer-readable media. In one aspect, the disclosure relates to such computer-readable media storing such executable instructions. The computer-readable media may store the instructions in a stable, non-transitory, form.

These and other aspects and implementations are discussed in detail below. The foregoing information and the following detailed description include illustrative examples of various aspects and implementations, and provide an overview or framework for understanding the nature and character of the claimed aspects and implementations.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of example computing systems in an example network environment;

FIG. 2 is a flowchart for an example method of monitoring a host that is infected with malware;

FIG. 3 is a flowchart for an example method of monitoring a host that might be infected with malware;

FIG. 4 is a flowchart illustrating coordination, in some implementations, between the example methods illustrated in FIGS. 2 and 3;

FIG. 5 is a diagrammatic view of one embodiment of a traffic model;

FIG. 6 is a flowchart for an example method of using observations from an infected host to detect malware infection;

FIG. 7 is a block diagram depicting one implementation of a general architecture of a computing device useful in connection with the methods and systems described herein; and

FIG. 8 is a block diagram depicting an implementation of an execution space for monitoring a computer program.

### DETAILED DESCRIPTION

Following below are more detailed descriptions of various concepts related to, and implementations of, methods, apparatuses, and systems introduced above. The various concepts introduced above and discussed in greater detail below may be implemented in any of numerous ways, as the concepts described are not limited to any particular manner of implementation. Examples of specific implementations and applications are provided primarily for illustrative purposes.

In general, a computing device may have one or more vulnerabilities that can be leveraged to compromise the computing device. Vulnerabilities include unintentional program flaws such as a buffer with inadequate overrun prevention, and intentional holes such as an undisclosed programmatic backdoor. Malicious code can, and has been, developed to exercise these various vulnerabilities to yield the execution of code chosen by, and possibly controlled by, an attacker. Malicious code implemented to target a particular vulnerability may be referred to as an exploit. For example, malicious code may codify, as an exploit, accessing an apparently benign interface and causing a buffer overflow that results in placement of unauthorized code into the execution stack where it may be run with elevated privileges. An attack could execute such an exploit and enable an unauthorized party to extract data from the computing device or obtain administrative control over the computing device. In some instances, the exploit code downloads additional components of the malware and modifies the operating system to become persistent. The computing device, now compromised, may be used for further attacks on other computing devices in a network or put to other malicious purposes.

Computing devices may also be compromised by deceiving a user into installing malicious software. For example, the malicious software may be packaged in a way that is appealing to the user or in a way that makes it similar to another known benign program (e.g., a program to display a video). A user may be deceived into installing malicious software without the user understanding what he or she has done.

Some compromised machines are configured to communicate with a remote endpoints, e.g., a command and control (“C & C”) system. For example, a compromised machine may check in with a C & C to receive instructions for how the compromised machine should be used (e.g., to send unsolicited e-mails, i.e., “spam,” or to participate in a distributed denial-of-service attack, “D-DOS”). A compromised machine is sometimes referred to as a “Bot” or a “Zombie” machine. A network of these machines is often referred to as a “botnet.”

Malicious code may be embodied in malicious software (“malware”). As used herein, malware includes, but is not limited to, computer viruses, worms, Trojans, rootkits, adware, and spyware. Malware may generally include any software that circumvents user or administrative controls. Malicious code may be created by an individual for a particular use. Exploits may be created to leverage a particular vulnerability and then adopted for various uses, e.g., in scripts or network attacks. Generally, because new forms of malicious behavior are designed and implemented on a regular basis, it is desirable to recognize previously unknown malicious code.

In some instances, malware may be designed to avoid detection. For example, malware may be designed to load into memory before malware detection software starts during a boot-up phase. Malware may be designed to integrate into an operating system present on an infected machine. Malware may bury network communication in apparently benign network communication. Malware may connect to legitimate network endpoints to obscure connections to control servers or other targets. In some instances, malware behaves in an apparently benign manner until a trigger event, e.g., a set day, arrives. In some instances, malware is reactive to environmental conditions. For example, malware may be designed to behave in an apparently benign manner in the presence of malware detection software.

Generally, suspicious computer code may be identified as malware by observing interactions between the suspicious computer code and remote network endpoints. Suspicious computer code may generate or receive data packets via a data network. For example, if a data packet has a source or destination endpoint matching a known command and control (“C & C”) server, then the code may be malicious. Likewise, if content of a data packet is consistent with traffic models (“signatures”) for the traffic produced by known malicious code, then the code may be malicious. In some implementations, the traffic models are based on the contents of communication (e.g., distinct patterns appearing within data packets). In some implementations, the traffic models are based on characteristics of the communication such as the size of the packets exchanged or the timing of the packets. Other methods and techniques may also be used as the basis for traffic models. A watch-list of known or suspected malicious servers (e.g., C & C servers) is maintained and a catalog of traffic models is maintained. For example, a new suspect endpoint may be identified when a monitored host exhibits malware-infected behavior after interacting with the suspect endpoint. The suspect endpoint can be added to the watch-list such that other infected hosts, and possibly the infectious malware, may then be identified when the other infected hosts communicate with the newly identified suspect endpoint. Likewise, new network interaction patterns (e.g., signatures) may be generated and added to the maintained catalog of traffic models.

Although a host computing system infected with malware is ostensibly under the control of a first party, the malware may execute instructions selected by another party (a malicious “second” party) via commands received by the malware from a remote network node. The remote network node, referred to as a “command and control” or “C & C” node, may also be an infected node, e.g., with an owner or operator who is unaware that the remote node is being used as a command and control node. The infected host executes instructions selected by the second party responsive to receiving commands from the command and control node. The executed instructions may be identified as malicious. For example, after connecting to a C & C host, the malware might try to modify the host computing system's operating system (e.g., to disable an automatic security update feature), try to shutdown virus or spyware detection software, try to install spyware, try to send spam emails, and so forth. A monitoring system, as described herein, can analyze malware behavior after a network interaction to correlate the behavior with the network interaction. The monitoring system learns from the correlations and can be used to improve prevention of future malware infection.

A monitoring system observes, and learns from, a host infected with malware. The monitoring system detects a connection to a remote network node that is known or suspected to be a malicious host, e.g., a command and control (“C & C”) node. After detecting the connection to the malicious host, the monitoring system detects an action performed by the malware. The action may be, for example, a modification to some aspect of the host computing system. The monitored actions can include one or more of: a modification of a Basic Input/Output System (BIOS); modification of an operating system file; modification of an operating system library file; modification of a library file shared between multiple software applications; modification of a configuration file; modification of an operating system registry; modification of a device driver; modification of a compiler; injection of code into a software process mid-execution; execution of an installed software application; installation of a software application; modification of an installed software application; or execution of a software package installer. Other actions may also be detected and monitored.

The monitoring system records information describing the network communication (e.g., generating a communication signature) and the subsequent action. The recorded information may then be used by the monitoring system to identify similar activity. For example, at some later point, the monitoring system may observe a computer connection between a host and a remote network node that does not have a reputation or is not known to be a malicious host. The host involved in the connection could be the one originally observed or a different one, and may be considered clean or only suspected of infection. Subsequent to the connection, the monitoring system detects or identifies an action on the host that is substantially similar to the actions previously performed by the malware. For example, the host may behave as though it had received the same instructions seen during the earlier monitoring. This may indicate (i) that the computer is infected, (ii) that the reputation-less remote node is a C & C host, and (iii) that a new signature is needed to identify the command and control communication. In some implementations, the monitoring system may take corrective action, or signal an administrator to take corrective action. In some implementations, the monitoring system may record reputation information for the remote network node, e.g., adding the node to a list of known-malicious nodes. In some implementations, the monitoring system may generate new traffic models (e.g., communication patterns or signatures) satisfied by the recorded network communication and add them to a catalog of traffic models for use in detecting future communications. In some implementations, the monitoring system allows connections to a known-malicious node and monitors the connections in order to see whether the malicious node is still exhibiting malicious behavior, and to confirm or update the catalog of traffic models based on communications over the allowed connections.

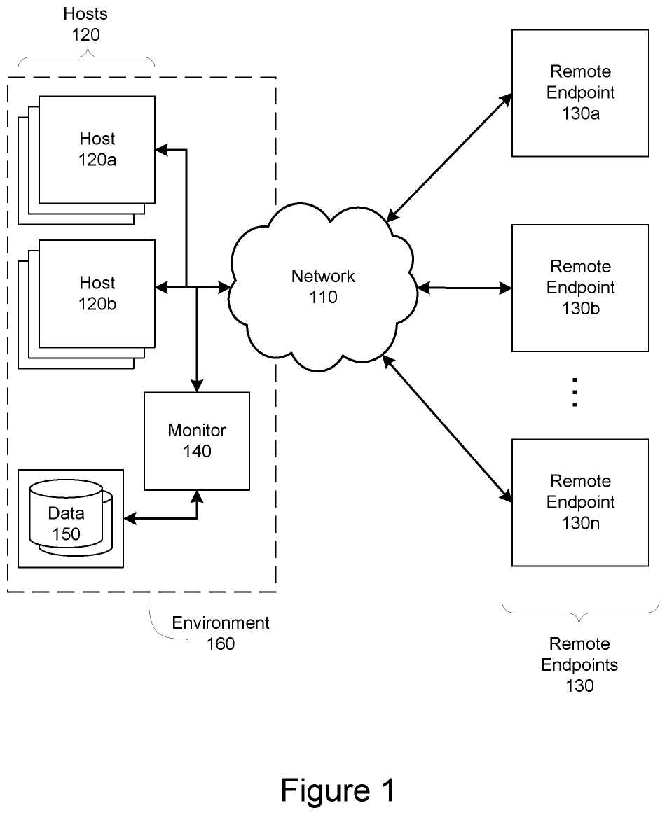

FIG. 1 is a block diagram of example computing systems in an example network environment. One or more hosts 120a, 120b, etc. (generically referred to as a host 120), communicate with one or more remote endpoints 130a, 130b, etc. (generically referred to as a remote endpoint 130) via a data network 110. The communication is observed by a monitor 140. Even though the monitor 140 is represented as separate from the host, the monitor 140 could also be placed within the host itself. The monitor 140 maintains a watch-list of suspect endpoints and a catalog of traffic models characterizing malicious network activity. In some embodiments, the watch-list and catalog are stored in computer readable memory, illustrated as data storage 150. In some embodiments, the hosts 120, the monitor 140, and the data storage 150 are in a controlled environment 160.

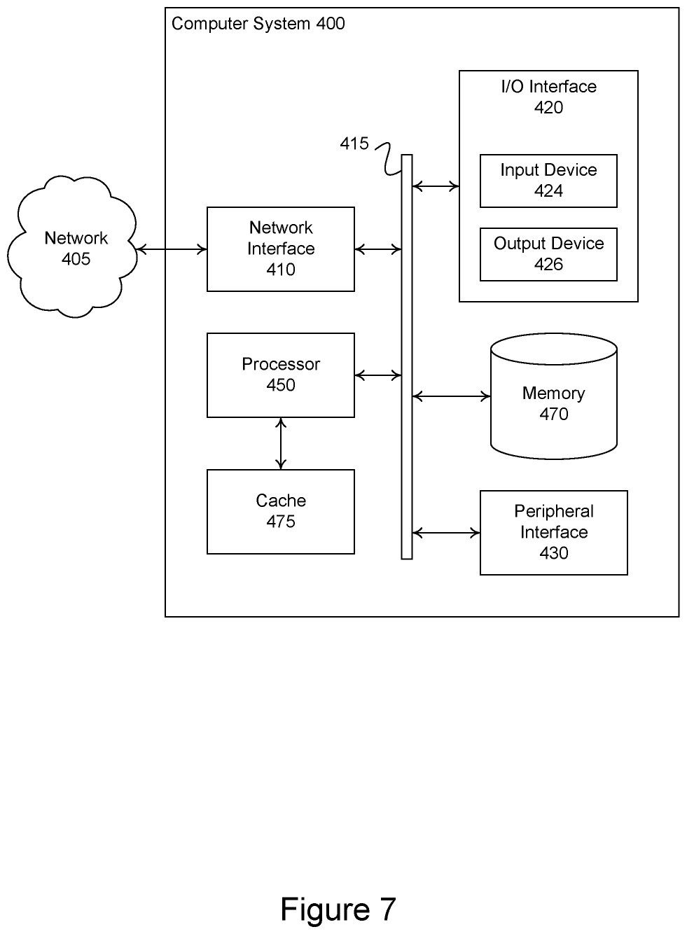

Each host 120 may be any kind of computing device, including but not limited to, a laptop, desktop, tablet, electronic pad, personal digital assistant, smart phone, video game device, television, server, kiosk, or portable computer. In other embodiments, the host 120 may be a virtual machine. The host 120 may be single-core, multi-core, or a cluster. The host 120 may operate under the control of an operating system. In some implementations, the host 120 can include devices that incorporate dedicated computer controllers, including, e.g., cameras, scanners, and printers (two or three dimensional), as well as automobiles, flying drones, robotic vacuum cleaners, and so forth. Generally, the host 120 may be any computing system susceptible to infection by malware, that is, any computing system. In some embodiments, the host 120 is a computing device 700, as illustrated in FIG. 7 and described below.

Each host 120 may communicate with one or more remote endpoints 130 via a data network 110. The network 110 can be a local-area network (LAN), such as a company intranet, a metropolitan area network (MAN), or a wide area network (WAN), such as the Internet and the World Wide Web. The network 110 may be any type and/or form of network and may include any of a point-to-point network, a broadcast network, a wide area network, a local area network, a telecommunications network, a data communication network, a computer network, an asynchronous transfer mode (ATM) network, a synchronous optical network (SONET), a wireless network, an optical fiber network, and a wired network. In some embodiments, there are multiple networks 110 between participants, for example a smart phone typically communicates with Internet servers via a wireless network connected to a private carrier network connected to the Internet. The network 110 may be public, private, or a combination of public and private networks. The topology of the network 110 may be a bus, star, ring, or any other network topology capable of the operations described herein.

The remote endpoints 130 may be network addressable endpoints. For example, a remote endpoint 130a may be a data server, a web site host, a domain name system (DNS) server, a router, or a personal computing device. A remote endpoint 130 may be represented by a network address, e.g., domain name or an IP address. An Internet Protocol (“IP”) address may be an IPv4 address, an IPv6 address, or an address using any other network addressing scheme. In some embodiments, an address for a remote endpoint 130 is an un-resolvable network address, that is, it may be an address that is not associated with a network device. Network communication to an un-resolvable address will fail until a network device adopts the address. For example, malware may attempt to communicate with a domain name that is not in use.

The communication between the host 120 and the remote endpoints 130 is observed by a monitor 140. In some embodiments, the monitor 140 is a distinct computing system monitoring the communication. For example, the host 120 and the monitor 140 may communicate with the network 110 via a shared router or switch. The monitor 140 may be configured to sniff packets on a local network, e.g., a network within a local computing environment 160. In some embodiments, the host 120 may be a virtual machine and the monitor 140 may be part of the virtual machine monitor (“VMM”). In some implementations, the monitor 140 is incorporated into a host 120. In some implementations, the monitor 140 is a set of circuits packaged into a portable device connected directly to a host 120 through a peripheral port such as a USB port. The packaged circuits may further include data storage 150.

The monitor 140 may maintain a watch-list of suspect endpoints and a catalog of traffic models characterizing malicious network activity. Generally, a watch-list of suspect endpoints is a set of addresses corresponding to remote endpoints 130 that are suspected of engaging in malicious network activity. For example, an address for a remote endpoint 130b that is identified as a C & C server may be added to a watch-list (sometimes referred to as a “black list”). Network communication routed to or from an endpoint on a watch-list may be blocked to prevent operation of malware, such as a botnet. Generally, a traffic model characterizing malicious network activity may be any information set used to recognize network traffic. An example model for recognizing messages between a specific malware loader, a Pushdo loader, and its associated C & C server, is illustrated in FIG. 5 and described in more detail below. Generally, the monitor 140 may compare the contents or routing behavior of communications between the host 120 and a remote endpoint 130n with the traffic models in the catalog.

In some embodiments, the watch-list and catalog are stored in computer readable memory, illustrated as data storage 150. In some embodiments, data storage 150 is random access memory provided by the monitor 140. Data storage systems suitable for use as storage 150 include volatile or non-volatile storage devices such as semiconductor memory devices, magnetic disk-based devices, and optical disc-based devices. A data storage device may incorporate one or more mass storage devices. Data storage devices may be accessed via an intermediary server and/or via a data network. In some implementations, the storage 150 is a network attached storage (NAS) system. In some implementations, the storage 150 is a storage area network (SAN). In some implementations, the storage 150 is geographically distributed. Data storage devices may be virtualized and/or cloud-based. In some implementations, the storage 150 is a database server. In some implementations, the storage 150 stores data in a file system as a collection of files or blocks of data. Data stored in the storage 150 may be encrypted. In some implementations, access to the storage 150 is restricted by one or more authentication systems. In some embodiments, data storage 150 is shared between multiple monitors 140. In some embodiments, data storage 150 stores data entries for each suspected endpoint and each traffic model characterizing malicious network activity.

In some embodiments, the host 120 and the monitor 140 are in a controlled environment 160. For example, the controlled environment 160 may be a local area network. In other embodiments, the host 120 may be a virtual machine and the monitor 140 may be part of the virtual machine monitor (“VMM”). In other embodiments, the monitor 140 may be a subsystem of the host 120.

FIG. 1 depicts a large number of hosts 120 monitored by a single monitoring system 140. However, in some implementations, the monitor 140 monitors only a single host 120, e.g., host 120b, in a one-to-one relationship. In some implementations, a pool of multiple monitoring systems 140 are responsible for monitoring multiple hosts 120. The exact ratio of hosts 120 to monitor systems 140 may be one-to-one, many-to-one, or many-to-many.

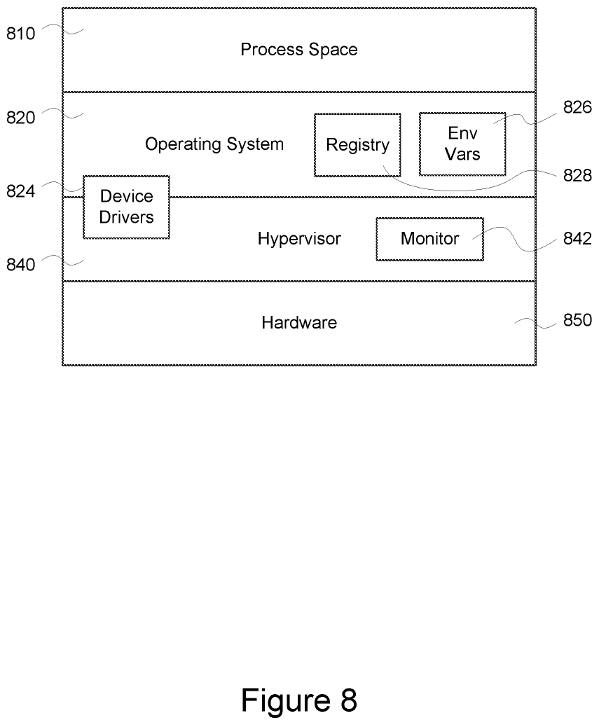

In some implementations, the monitor system 140 relies on hardware located in, or software executing on, a host 120 to assist with the monitoring. For example, in some implementations, each host 120 includes a library of hooking functions that intercept one or more library calls and notify the monitor system 140 of each intercepted call. In some implementations, the host 120 is a virtual machine running on a hypervisor. In some such implementations, the hypervisor is configured to notify the monitor system 140 of calls to one or more specific library or operating system functions. In some implementations, the hypervisor includes or hosts the monitor system 140. In some implementation, the monitor system 140 is external to the hypervisor and uses virtual machine introspection (“VMI”) techniques to remotely monitor the virtual machine. For example, in some VMI implementations, the monitor system 140 inspects memory elements used by the virtual machine operating system and/or process space. In some VMI implementations, the monitor system 140 analyzes an activity log. In some VMI implementations, the monitor system 140 analyzes activity in real-time. FIG. 8, described below, is a block diagram depicting one example implementation of an execution space for monitoring a computer program.

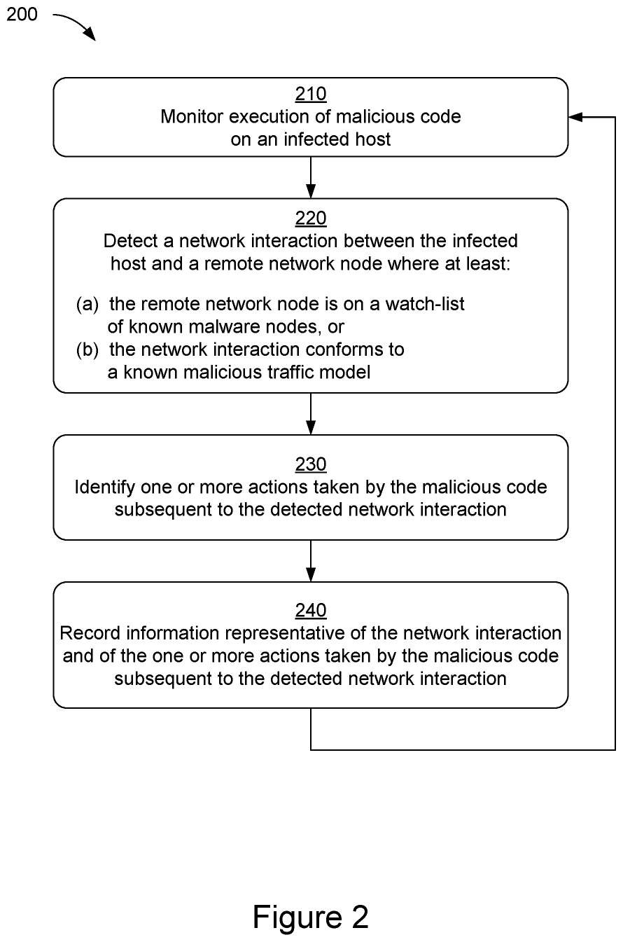

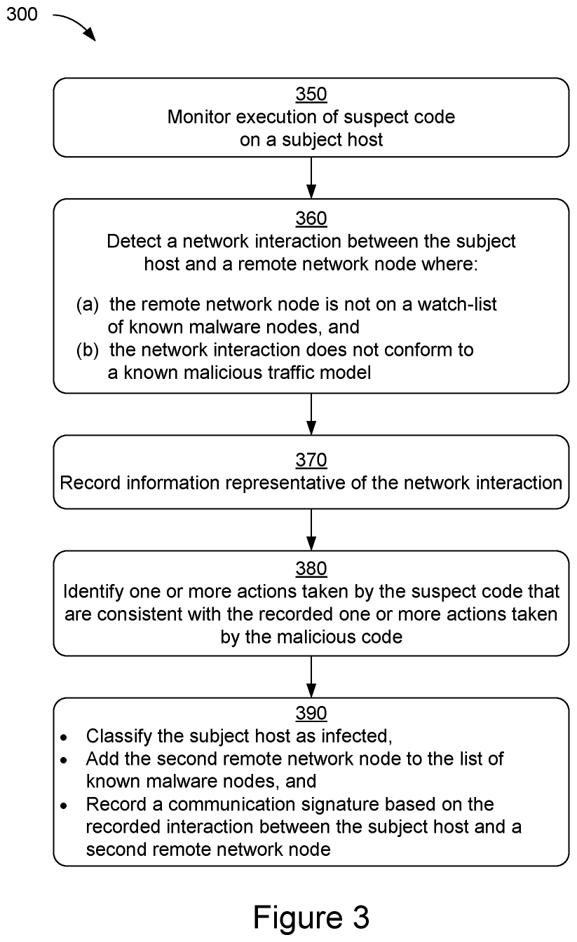

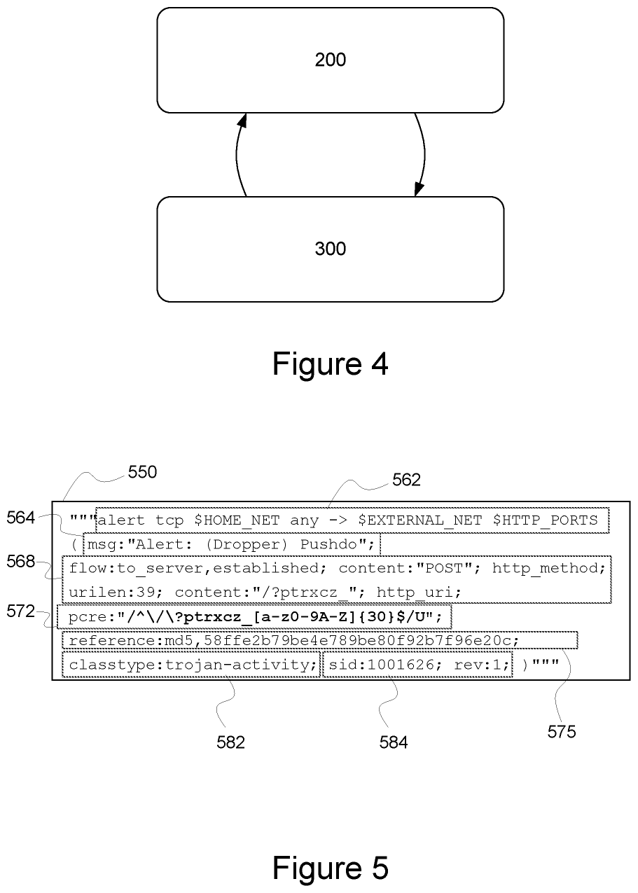

FIG. 2 is a flowchart for an example method 200 of monitoring a host that is infected with malware. In a broad overview of the method 200, at stage 210, a monitoring system 140 monitors execution of malicious code on an infected host 120. At stage 220, the monitoring system 140 detects a network interaction between the infected host 120 and a remote network node 130. At stage 230, the monitoring system 140 identifies one or more actions taken by the malicious code subsequent to the detected network interaction. At stage 240, the monitoring system 140 records information representative of the network interaction and representative of the one or more actions taken by the malicious code subsequent to the detected network interaction. The monitoring system 140 records this information in data storage 150 and continues monitoring execution of malicious code at stage 210. The recorded information may then be used in the method 300 illustrated in FIG. 3, as shown in FIG. 4 and described below.

Referring to FIG. 2 in more detail, at stage 210, the monitoring system 140 monitors execution of malicious code on an infected host 120, e.g., host 120a illustrated in FIG. 1. In some implementations, the infected host 120 is known to be infected with the malicious code. For example, in some implementations, the host 120 may be intentionally infected by an administrator so that it may be monitored. In some implementations, the host 120 is a “honey pot,” with known vulnerabilities that are left intentionally unpatched in the hopes that it will be attacked and the attacks can be observed. In some implementations, the host 120 is discovered to be infected using the method 300, described below in reference to FIG. 3. In some implementations, the monitoring system 140 executes the malicious code in a controlled manner. In some implementations, the monitoring system 140 allows the malicious code to execute on the infected host 120 freely until the infected host 120 communicates with a remote network node. The monitoring system 140 then observes the communication and determines whether the remote network node is on a watch-list of remote network nodes and/or whether the communication includes a network interaction that conforms to a known malicious traffic model in a catalog of traffic models characterizing malicious network activity. In some implementations, the infected host 120 is not known to be infected with the malicious code. The monitoring system 140 determines that the host 120 is infected with malicious code based on the network communication detected at stage 220, which indicates that the monitored node is an infected node. That is, in some implementations, the monitoring system 140 monitors one or more nodes regardless of their respective infection status and the method 200 is invoked when it turns out that a monitored host is an infected host.

At stage 220, the monitoring system 140 detects a network interaction between the infected host 120 and a remote network node 130 where either (a) the remote network node is on a watch-list of known malware nodes, or (b) the network interaction conforms to a known malicious traffic model, e.g., a signature for malware communications. The detected network interaction is likely to be an interaction with a remote network node that is a command and control node or is part of a command and control infrastructure. In some implementations, if the network interaction conforms to a known malicious traffic model, but the remote network node does not have a reputation or is not on the watch-list of known malware nodes, then the monitoring system 140 may add the remote network node to the watch-list. In some implementations, if the remote network node is on the watch-list, but the network interaction does not conform to a known malicious traffic model, then the monitoring system 140 may generate a new traffic model for the network interaction.

At stage 230, the monitoring system 140 identifies one or more actions taken by the malicious code subsequent to the detected network interaction. In some implementations, the monitoring system 140 determines if the identified actions are malicious, e.g., if the malicious code modified an environment setting, altered an operating system file or configuration, accessed a registry entry, opened new network connections, sent instructions to an e-mail program, attempted to generate spam e-mails, etc. In some implementations, the monitoring system determines whether the identified actions were triggered by the detected network interaction. For example, in some implementations, the monitoring system 140 assumes a correlation between the detected network interaction and any action taken by the malicious code subsequent to the network interaction. In some implementations, the monitoring system identifies actions taken by the malicious code by observing an execution trace. In some implementations, the monitoring system uses a hooking mechanism to identify actions taken by the malicious code, as described above.

At stage 240, the monitoring system 140 records information representative of the network interaction, and of one or more actions taken by the malicious code subsequent to the detected network interaction. The monitoring system 140 records this information in data storage 150. In some implementations, the monitoring system only records information for malicious actions. In some implementations, the monitoring system records information for all identified actions taken by the malicious code subsequent to the network interaction detected in stage 220. The monitoring system 140 continues monitoring execution of malicious code at stage 210.

FIG. 3 is a flowchart for an example method 300 of monitoring a host that might be infected with malware. In a broad overview of the method 300, at stage 350, the monitoring system 140 monitors execution of suspect code on a subject host 120. The subject host 120 may be the infected host 120a, used in the method 200 described above, or the subject host 120 may be another host 120b. At stage 360, the monitoring system 140 detects a network interaction between the subject host and a remote network node that does not initially appear suspicious. At stage 370, the monitoring system 140 records information representative of the network interaction and at stage 380, the monitoring system 140 identifies one or more actions taken by the suspect code that are consistent with, or substantially similar to, the one or more actions identified at stage 230 and recorded at stage 240 in the method 200, described above. At stage 390, responsive to the identification in stage 380, the monitoring system 140 determines that malicious code is active and takes one or more remedial steps, e.g., classifying the subject host 120 as infected, adding the remote network node to a watch-list of known malware nodes (e.g., command and control nodes), and recording a traffic model (e.g., a signature) based on the interaction between the subject host 120 and the remote network node detected at stage 360 and recorded at stage 370. The recorded information may then be used in the method 200 illustrated in FIG. 2. Further, in some implementations, the host remains infected and is monitored using the method 200, as shown in FIG. 4.

Referring to FIG. 3 in more detail, at stage 350, the monitoring system 140 monitors execution of suspect code on a subject host 120. The subject host 120 may be the infected host 120a monitored in the method 200. For example, the infected host may have been cleaned prior to use of the method 300. The subject host 120 may be another host, e.g., host 120b, which has not been known to have been infected. In some implementations, the method 200 and the method 300 are performed by different monitoring systems 140, using a shared data storage 150. The methods 200 and 300 may be performed concurrently.

At stage 360, monitoring system 140 detects a network interaction between the subject host 120 and a remote network node 130 that does not initially appear suspicious. For example, the network interaction does not initially appear suspicious when the remote network node is not on a on a watch-list of known malware nodes and the network interaction does not conform to a known malicious traffic model. In some implementations, the monitoring system 140 maintains reputation data for remote network nodes, e.g., keeping a list of network nodes that are safe to interact with and/or keeping a list of network nodes that are not safe to interact with. In some implementations, a network interaction with a remote network node 130 that has no reputation data is not initially suspicious.

At stage 370, the monitoring system 140 records information representative of a network interaction between the subject host 120 and a remote network node 130, which may be the same remote node observed in stage 220 or may be a second remote network node 130.

At stage 380, the monitoring system 140 identifies one or more actions taken by the suspect code that are consistent with, or substantially similar to, the one or more actions taken by the malicious code as recorded at stage 240.

At stage 390, responsive to the identification in stage 380, the monitoring system 140 determines that malicious code is active and takes one or more remedial steps, e.g., classifying the subject host 120 as infected, adding the remote network node to a watch-list of known malware nodes (e.g., command and control nodes), and recording a traffic model (e.g., a signature) based on the recorded interaction between the subject host 120 and the remote network node.

FIG. 4 is a flowchart illustrating coordination, in some implementations, between the example methods 200 and 300, respectively illustrated in FIGS. 2 and 3. FIG. 4 illustrates that if the monitoring system 140 determines that the subject host is infected with malicious code (e.g., malware), e.g., using the method 300, then the monitoring system 140 may monitor the infected host using the method 200. The method 300 may be used with an infected host to identify new remote network nodes that host malware or participate in a command and control structure. Likewise, the method 300 may be used with an infected host to identify new traffic models for network interactions between infected hosts and remote network nodes. The methods 200 and 300 may be used in a cyclic manner, as shown in FIG. 4.

FIG. 5 illustrates an example model for recognizing messages. Traffic models may be based on contents of data communication (e.g., distinct patterns appearing within data packets), or communication characteristics such as the size of the packets exchanged or the timing of the packets, or some combination thereof. Other methods and techniques may also be used as the basis for traffic models. Referring to FIG. 5, the example traffic model 550 recognizes a communication as part of a malicious network activity. The traffic model 550 may include, for example, control information 562, an alert message 564, patterns for protocol information and routing information 568, content patterns 572, hash values 575, classification information 582, and versioning information 584. In the example traffic model 550 illustrated in FIG. 5, a regular expression 572 matches content for a Pushdo loader and a message digest 575 that characterizes the binary program that generated the traffic. The Pushdo loader is malware that is used to install (or load) modules for use of an infected machine as a bot. For example, Pushdo has been used to load Cutwail and create large numbers of spam bots. The traffic model 550 for recognizing Pushdo is provided as an example signature.

Generally, the monitor 140 may compare the contents or routing behavior of communications between the host 120 and a remote endpoint 130n with a traffic model 550, e.g., as found in a catalog of traffic models characterizing malicious network activity. A traffic model 550 may be generated for traffic known to be malicious network activity by identifying characteristics of the network traffic. The traffic model 550 is a type of “signature” for the identified malicious network activity.

A regular expression 572 may be used to identify suspect network communication. A regular expression may be expressed in any format. One commonly used set of terminology for regular expressions is the terminology used by the programming language Perl, generally known as Perl regular expressions, “Perl RE,” or “Perl RegEx.” (POSIX BRE is also common). Network communications may be identified as matching a traffic model 550 if a communication satisfies the regular expression 572 in the traffic model 550. A regular expression to match a set of strings may be generated automatically by identifying common patterns across the set of strings and generating a regular expression satisfied by a common pattern. In some embodiments, other characteristics are used as a model. For example, in some embodiments, packet length, number of packets, or repetition of packets is used as a model. In some embodiments, content repetition within a packet is used as a model. In some embodiments, timing of packets is used as a model.

A message digest 575 may be used to characterize a block of data, e.g., a binary program. One commonly used message digest algorithm is the “md5 hash” algorithm created by Dr. Rivest. In some embodiments, network communications may be identified if a message digest for a program generating or receiving the communication is equivalent to the message digest 575 in the traffic model 550.

Control information 562 may be used to control or configure use of the traffic model. The example traffic model illustrated in FIG. 5 is applied to TCP flows using port $HTTP_PORTS, e.g., 80, 443, or 8080.

An alert message 564 may be used to signal an administrator that the traffic model has identified suspect network traffic. The alert message 564 may be recorded in a log. The alert message 564 may be transmitted, e.g., via a text message or e-mail. The alert message 564 may be displayed on a screen. In some embodiments, a generic alert message is used. In some embodiments, an alert message is generated based on available context information.

Patterns for protocol information and routing information 568 may indicate various protocols or protocol indicators for the traffic model. For example, as illustrated in FIG. 5, the Pushdo traffic uses the HTTP protocol.

Classification information 582 may be used to indicate the type of suspect network activity. For example, as illustrated in FIG. 5, Pushdo is a Trojan. Other classifications may include, for example, “virus,” “worm,” “drive-by,” or “evasive.” The classification may indicate that the network traffic is consistent with a particular malware replication or delivery mechanism. For example, “drive-by” may indicate that the network traffic is consistent with surreptitious downloads triggered during otherwise innocuous network activity. A classification as “evasive” may indicate that the activity is associated with evasive malware or malicious code. Malware or malicious code is generally evasive when it includes code designed to evade detection. For example, some malicious code will remain dormant unless the host computing environment meets certain criteria. When the code is dormant, it may be difficult to detect.

Versioning information 584 may be used to assign an identifier (e.g., signature ID) and or a version number for the traffic model.

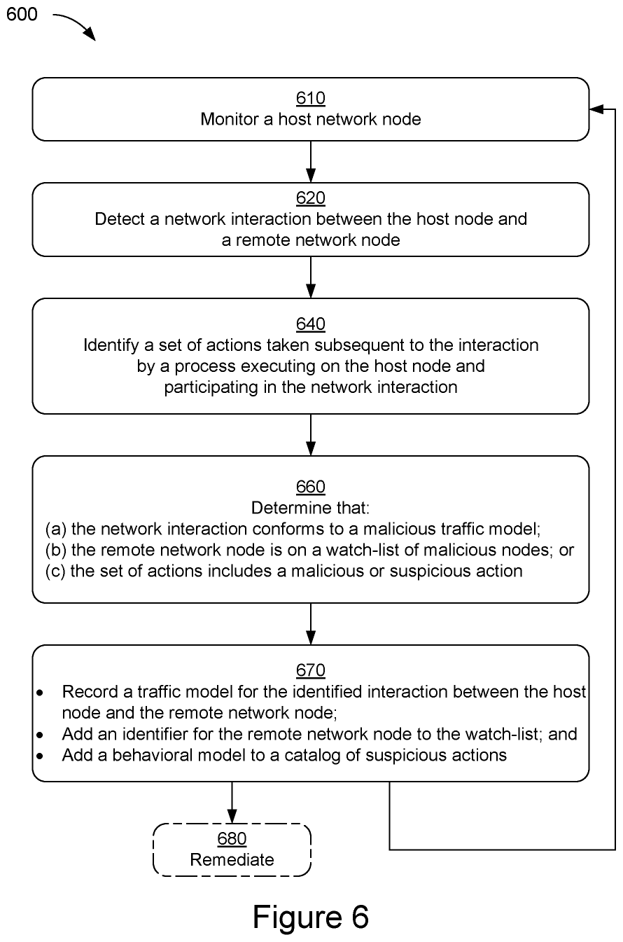

FIG. 6 is a flowchart for an example method 600 of using observations from an infected host to detect malware infection. In a broad overview of method 600, at stage 610, a monitoring system 140 monitors a host network node 120. At stage 620, the monitoring system 140 detects a network interaction between the host node 120 and a remote network node 130. At stage 640, the monitoring system 140 identifies a set of actions taken subsequent to the interaction by a process executing on the host node and participating in the network interaction. At stage 660, the monitoring system 140 determines that the network interaction and/or the subsequent action indicates that the identified process is malware. At stage 680, the monitoring system 140 records information describing the network interaction and the subsequent actions for use in detecting future malware infections. The monitoring system 140 may then, at stage 680, take remedial action, e.g., remove the identified process from the host 120, or the monitoring system 140 may continue monitoring the infected host 120 at stage 610. Additional information may be gleaned from further monitoring of the infected host 120.

Referring to FIG. 6 in more detail, at stage 610, a monitoring system 140 monitors a host network node 120. Monitoring the host node 120 is described above in reference to FIGS. 2 and 3.

At stage 620, the monitoring system 140 detects a network interaction between the host node 120 and a remote network node 130. In some implementations, the monitoring system 140 monitors all network interactions entering or exiting the protected environment 160. In some implementations, the monitoring system 140 detects new stateful network flows, such as Transmission Control Protocol (TCP) or Stream Control Transmission Protocol (SCTP) flows, based on detecting handshake initiation messages used to establish such flows. In some implementations, the monitoring system 140 determines if the network interaction includes one or more indicators of malicious activity. For example, in some implementations, the monitoring system 140 determines if the network interaction conforms to a traffic model for malicious network activity and/or if the network interaction is an interaction with a remote network node represented on a watch-list of malicious end nodes. In some implementations, the monitoring system 140 may determine to block the network activity if it determines that the network interaction includes an indicator of malicious activity. However, in some implementations, the monitoring system 140 may determine to allow (or at least not to block) the network activity despite determining that the network interaction includes an indicator of malicious activity. For example, if the network interaction is an interaction with a remote network node represented on a watch-list of malicious end nodes, the monitoring system 140 may monitor the network interaction and treat the host network node as an infected network node. That is, the monitoring system 140 may allow one or more data packets to pass through to the remote network node. If the network interaction fails, e.g., because the remote network node does not respond, this could indicate that the remote network node is no longer active. In some implementations, the monitoring system 140 uses this information (i.e., the communication failure) to remove the remote network node from the watch-list. If the network interaction succeeds, the monitoring system 140 records information about the network interaction. In some implementations, the recorded information is used to update records about the malicious activity, e.g., to generate new traffic models for the network interaction.

At stage 640, the monitoring system 140 identifies a set of actions taken subsequent to the interaction by a process executing on the host node and participating in the network interaction. In some implementations, the set of actions conform to a behavioral model. For example, the set of actions may include a modification to an environmental setting, or disabling one or more operating system features, or disabling an anti-virus tool, or instantiating an e-mail service, or establishing an inter-process connection to an e-mail software application, or opening a number of network connections at an unusual rate (e.g., opening more than a threshold number of connections within a predefined window of time), or copying files to a staging directory, or any other activity modeled by one or more behavioral models in a catalog of such models. In some implementations, the monitoring system 140 identifies all actions taken by any process within a predefined length of time after a network interaction. In some implementations, the monitoring system 140 identifies a predefined number of actions taken by any process after a network interaction without regard to time. In some implementations, the monitoring system 140 identifies only high-risk actions, such as writing data to disk with an unusual file type for the process, modifying operating system configurations, editing shared libraries (e.g., DLL files), or disabling other software applications.

At stage 660, the monitoring system 140 determines that the network interaction and/or the subsequent action indicates that the identified process is malware. In some implementations, the monitoring system 140 determines that the identified process is malware based on a determination that the network interaction conforms to a malicious traffic model. In some implementations, the monitoring system 140 determines that the identified process is malware based on a determination that the network interaction connects to a remote network node that is on a watch-list of malicious nodes. In some implementations, the monitoring system 140 determines that the identified process is malware based on a determination that the set of actions taken subsequent to the network interaction includes a malicious or suspicious action. For example, in some implementations, the monitoring system maintains a catalog of malicious behavior models and determines that the subsequent actions taken by the identified process conform to a model in the catalog of malicious behavior models. In some implementations, the monitoring system 140 determines that the identified process is malware based on any combination of (a) determining that the network interaction conforms to a malicious traffic model; (b) determining that the remote network node is on a watch-list of malicious nodes; and/or (c) determining that the set of actions includes a malicious or suspicious action.

At stage 670, the monitoring system 140 records information describing the network interaction and the subsequent actions for use in detecting future malware infections. For example, in some implementations, the monitoring system 140 records a traffic model for the identified interaction between the host node and the remote network node, adds an identifier for the remote network node to the watch-list, and adds the behavioral model identified in stage 640 to a catalog of suspicious actions. The monitoring system 140 may then, at stage 680, take remedial action, e.g., remove the identified process from the host 120, or the monitoring system 140 may continue monitoring the infected host 120 at stage 610.

At stage 680, the monitoring system 140 takes remedial action. For example, the monitoring system may remove the identified process from the host 120. In some implementations, remedial action may include generating a signal or alert notifying an administrator of the malware. In some implementations, the remedial action may include isolating the infected host node 120 from other hosts 120 in a protected environment 160. In some implementations, remediation may include distributing updated traffic models, watch-lists, and/or malicious behavior models to third parties.

FIG. 7 is a block diagram illustrating a general architecture of a computing system 700 useful in connection with the methods and systems described herein. The example computing system 700 includes one or more processors 750 in communication, via a bus 715, with one or more network interfaces 710 (in communication with a network 705), I/O interfaces 720 (for interacting with a user or administrator), and memory 770. The processor 750 incorporates, or is directly connected to, additional cache memory 775. In some uses, additional components are in communication with the computing system 700 via a peripheral interface 730. In some uses, such as in a server context, there is no I/O interface 720 or the I/O interface 720 is not used. In some uses, the I/O interface 720 supports an input device 724 and/or an output device 726. In some uses, the input device 724 and the output device 726 use the same hardware, for example, as in a touch screen. In some uses, the computing device 700 is stand-alone and does not interact with a network 705 and might not have a network interface 710.

In some implementations, one or more computing systems described herein are constructed to be similar to the computing system 700 of FIG. 7. For example, a user may interact with an input device 724, e.g., a keyboard, mouse, or touch screen, to access an interface, e.g., a web page, over the network 705. The interaction is received at the user's device's interface 710, and responses are output via output device 726, e.g., a display, screen, touch screen, or speakers.

The computing device 700 may communicate with one or more remote computing devices via a data network 705. The network 705 can be a local-area network (LAN), such as a company intranet, a metropolitan area network (MAN), or a wide area network (WAN), such as the Internet and the World Wide Web. The network 705 may be any type and/or form of network and may include any of a point-to-point network, a broadcast network, a wide area network, a local area network, a telecommunications network, a data communication network, a computer network, an asynchronous transfer mode (ATM) network, a synchronous optical network (SONET), a wireless network, an optical fiber network, and a wired network. In some implementations, there are multiple networks 705 between participants, for example a smart phone typically communicates with Internet servers via a wireless network connected to a private corporate network connected to the Internet. The network 705 may be public, private, or a combination of public and private networks. The topology of the network 705 may be a bus, star, ring, or any other network topology capable of the operations described herein.

In some implementations, one or more devices are constructed to be similar to the computing system 700 of FIG. 7. In some implementations, a server may be made up of multiple computer systems 700. In some implementations, a server may be a virtual server, for example, a cloud-based server accessible via the network 705. A cloud-based server may be hosted by a third-party cloud service. A server may be made up of multiple computer systems 700 sharing a location or distributed across multiple locations. The multiple computer systems 700 forming a server may communicate using the user-accessible network 705. The multiple computer systems 700 forming a server may communicate using a private network, e.g., a network distinct from a publicly-accessible network or a virtual private network within a publicly-accessible network.

The processor 750 may be any logic circuitry that processes instructions, e.g., instructions fetched from the memory 770 or cache 775. In many implementations, the processor 750 is a microprocessor unit. The processor 750 may be any processor capable of operating as described herein. The processor 750 may be a single core or multi-core processor. The processor 750 may be multiple processors.

The I/O interface 720 may support a wide variety of devices. Examples of an input device 724 include a keyboard, mouse, touch or track pad, trackball, microphone, touch screen, or drawing tablet. Example of an output device 726 include a video display, touch screen, speaker, inkjet printer, laser printer, dye-sublimation printer, or 3D printer. In some implementations, an input device 724 and/or output device 726 may function as a peripheral device connected via a peripheral interface 730.

A peripheral interface 730 supports connection of additional peripheral devices to the computing system 700. The peripheral devices may be connected physically, as in a universal serial bus (USB) device, or wirelessly, as in a Bluetooth™ device. Examples of peripherals include keyboards, pointing devices, display devices, audio devices, hubs, printers, media reading devices, storage devices, hardware accelerators, sound processors, graphics processors, antennas, signal receivers, measurement devices, and data conversion devices. In some uses, peripherals include a network interface and connect with the computing system 700 via the network 705 and the network interface 710. For example, a printing device may be a network accessible printer.

The computing system 700 can be any workstation, desktop computer, laptop or notebook computer, server, handheld computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein.

FIG. 8 is a block diagram depicting one implementation of an execution space for monitoring a computer program. In general, a computing environment comprises hardware 850 and software executing on the hardware. A computer program is a set of instructions executed by one or more processors (e.g., processor 750). In a simplified view, the program instructions manipulate data in a process space 810 within the confines of an operating system 820. The operating system 820 generally controls the process space 810 and provides access to hardware 850, e.g., via device drivers 824. Generally, an operating system 820 may provide the process space 810 with various native resources, e.g., environmental variables 826 and/or a registry 828. In some implementations, the operating system 820 runs on a hypervisor 840, which provides a virtualized computing environment. The hypervisor 840 may run in the context of a second operating system or may run directly on the hardware 850. Generally, software executing in the process space 810 is unaware of the hypervisor 840. The hypervisor 840 may host a monitor 842 for monitoring the operating system 820 and process space 810.

The process space 810 is an abstraction for the processing space managed by the operating system 820. Generally, program code is loaded by the operating system into memory allocated for respective programs and the processing space 810 represents the aggregate allocated memory. Software typically executes in the process space 810. Malware detection software running in the process space 810 may have a limited view of the overall system, as the software is generally constrained by the operating system 820.

The operating system 820 generally controls the process space 810 and provides access to hardware 850, e.g., via device drivers 824. An operating system typically includes a kernel and additional tools facilitating operating of the computing platform. Generally, an operating system 820 may provide the process space 810 with various native resources, e.g., environmental variables 826 and/or a registry 828. Examples of operating systems include any of the operating systems from Apple, Inc. (e.g., OS X or iOS), from Microsoft, Inc. (e.g., any of the Windows® family of operating systems), from Google Inc. (e.g., Chrome or Android), or Bell Lab's UNIX and its derivatives (e.g., BSD, FreeBSD, NetBSD, Linux, Solaris, AIX, or HP/UX). Some malware may attempt to modify the operating system 820. For example, a rootkit may install a security backdoor into the operating system.

Environmental variables 826 may include, but are not limited to: a clock reporting a time and date; file system roots and paths; version information; user identification information; device status information (e.g., display active or inactive or mouse active or inactive); an event queue (e.g., graphic user interface events); and uptime. In some implementations, an operating system 820 may provide context information to a process executing in process space 810. For example, a process may be able to determine if it is running within a debugging tool.

An operating system 820 may provide a registry 828, e.g., Windows Registry. The registry may store one or more environmental variables 826. The registry may store file type association, permissions, access control information, path information, and application settings. The registry may comprise entries of key/value pairs.

In some implementations, the operating system 820 runs on a hypervisor 840, which provides a virtualized computing environment. The hypervisor 840, also referred to as a virtual machine monitor (“VMM”), creates one or more virtual environments by allocating access by each virtual environment to underlying resources, e.g., the underlying devices and hardware 850. Examples of a hypervisor 820 include the VMM provided by VMware, Inc., the XEN hypervisor from Xen.org, or the virtual PC hypervisor provided by Microsoft. The hypervisor 840 may run in the context of a second operating system or may run directly on the hardware 850. The hypervisor 840 may virtualize one or more hardware devices, including, but not limited to, the computing processors, available memory, and data storage space. The hypervisor can create a controlled computing environment for use as a testbed or sandbox. Generally, software executing in the process space 810 is unaware of the hypervisor 840.

The hypervisor 840 may host a monitor 842 for monitoring the operating system 820 and process space 810. The monitor 842 can detect changes to the operating system 820. The monitor 842 can modify memory virtualized by the hypervisor 840. The monitor 842 can be used to detect malicious behavior in the process space 810.

Device drivers 824 generally provide an application programming interface (“API”) for hardware devices. For example, a printer driver may provide a software interface to a physical printer. Device drivers 824 are typically installed within an operating system 820. Device drivers 824 may be modified by the presence of a hypervisor 840, e.g., where a device is virtualized by the hypervisor 840.

The hardware layer 850 may be implemented using the computing device 700 described above. The hardware layer 850 represents the physical computer resources virtualized by the hypervisor 840.

Environmental information may include files, registry keys for the registry 828, environmental variables 826, or any other variable maintained by the operating system. Environmental information may include an event handler or an event queue. For example, a Unix kQueue. Environmental information may include presence or activity of other programs installed or running on the computing machine. Environmental information may include responses from a device driver 824 or from the hardware 850 (e.g., register reads, or responses from the BIOS or other firmware).

It should be understood that the systems and methods described above may be provided as instructions in one or more computer programs recorded on or in one or more articles of manufacture, e.g., computer-readable media. The article of manufacture may be a floppy disk, a hard disk, a CD-ROM, a flash memory card, a PROM, a RAM, a ROM, or a magnetic tape. In general, the computer programs may be implemented in any programming language, such as LISP, Perl, C, C++, C #, Python, PROLOG, or in any byte code language such as JAVA. The software programs may be stored on or in one or more articles of manufacture as object code.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Having described certain implementations and embodiments of methods and systems, it will now become apparent to one of skill in the art that other embodiments incorporating the concepts of the disclosure may be used. Therefore, the disclosure should not be limited to certain implementations or embodiments, but rather should be limited only by the spirit and scope of the following claims.

What is claimed is:

1. A method of detecting malicious network activity, the method comprising:
monitoring execution of malicious code on an infected network node;
detecting a control interaction between the infected network node and a first remote network node;
recording, in a knowledge base, first information representative of one or more actions taken by the malicious code subsequent to the control interaction;
monitoring execution of suspect code on a protected network node;
recording, in a communication log, second information representative of a second network interaction between the protected network node and a second remote network node;
detecting one or more actions taken by the suspect code consistent with the one or more actions taken by the malicious code represented in the recorded first information; and
based on detecting the one or more actions taken by the suspect code:
(a) classifying the protected network node as infected,
(b) identifying the second remote network node as a malicious end node, and
(c) recording, in the knowledge base, a traffic model based on the recorded second information representative of the second network interaction.

2. The method of claim 1, further comprising
maintaining a watch-list of malicious end nodes, the watch-list containing network addresses corresponding to network nodes identified as one or more of: malware controllers, components of malware control infrastructure, and malware information sinks;
adding, to the watch-list, an identification including at least a network address for the second remote network node; and
selectively blocking the protected network node from establishing network connections with network nodes identified in the list.

3. The method of claim 2, further comprising
detecting an attempt by the protected network node to establish a network connection to a third remote network node identified by a third network address in the watch-list;
allowing the protected network node to send a network packet to the third remote network node;
determining that the network packet fails to reach the third remote network node; and
removing identification of the third remote network node from the watch-list.

4. The method of claim 1, wherein the infected network node and the protected network node are the same network node.

5. The method of claim 1, wherein the first remote network node is one of: a command and control center, an exploit delivery site, a malware distribution site, a malware information sink, or a bot in a peer-to-peer botnet.

6. The method of claim 1, wherein recording information for the first network interaction comprises sniffing packets on a network and recording a pattern satisfied by the sniffed packets.

7. The method of claim 1, wherein recording the first information representative of the one or more actions taken by the malicious code subsequent to the first network interaction comprises:
generating a behavioral model of the one or more actions taken by the malicious code subsequent to the first network interaction; and
recording the behavioral model in the knowledge base.

8. The method of claim 1, wherein the one or more actions taken by the suspect code cause a first result and the one or more actions taken by the malicious code cause a second result, wherein the one or more actions taken by the suspect code are consistent with the one or more actions taken by the malicious code when the first result is equivalent to the second result.

9. The method of claim 8, wherein the first result is one or more of: an operating system setting is changed, an operating system feature is disabled, or a network connection is established.

10. The method of claim 1, wherein the one or more actions taken by the suspect code include at least one of:
modification of a Basic Input/Output System (BIOS);
modification of an operating system file;
modification of an operating system library file;
modification of a library file shared between multiple software applications;
modification of a configuration file;
modification of an operating system registry;
modification of a device driver;
modification of a compiler;
injection of code into a software process mid-execution;
execution of an installed software application;
installation of a software application;
modification of an installed software application; or
execution of a software package installer.

11. A system for detecting malicious network activity, the system comprising:
a first computer readable memory storing a knowledge base;
a second computer readable memory storing a communication log;
a monitor comprising at least one computer processor configured to execute instructions, that, when executed by a computer processor, cause the computer processor to:
monitor execution of malicious code on an infected network node;
detect a control interaction between the infected network node and a first remote network node;
record, in the knowledge base, a behavioral model representative of one or more actions taken by the malicious code subsequent to the first network interaction;
monitor execution of suspect code on a protected network node;
record, in the communication log, information representative of a second network interaction between the protected network node and a second remote network node;
detect one or more actions taken by the suspect code consistent with the behavioral model; and
based on detecting the one or more actions taken by the suspect code:
(a) classify the protected network node as infected,
(b) identify the second remote network node as a malicious end node, and
(c) record, in the knowledge base, a traffic model based on the recorded information for the second network interaction.

12. The system of claim 11, the instructions, when executed, further causing the at least one computer processor to:
maintain a watch-list of malicious end nodes, the watch-list containing network addresses corresponding to network nodes identified as one or more of: malware controllers, components of malware control infrastructure, and malware information sinks;
add, to the watch-list, an identification including at least a network address for the second remote network node; and
selectively block the protected network node from establishing network connections with network nodes identified in the list.

13. The system of claim 12, the instructions, when executed, further causing the at least one computer processor to:
detect an attempt by the protected network node to establish a network connection to a third remote network node identified by a third network address in the watch-list;
allow the protected network node to send a network packet to the third remote network node;
determine that the network packet fails to reach the third remote network node; and
remove identification of the third remote network node from the watch-list.

14. The system of claim 11, wherein the infected network node and the protected network node are the same network node.

15. The system of claim 11, wherein the first remote network node is one of: a command and control center, an exploit delivery site, a malware distribution site, a malware information sink, or a bot in a peer-to-peer botnet.

16. The system of claim 11, the instructions, when executed, further causing the at least one computer processor to record information for the first network interaction by sniffing packets on a network and recording a pattern satisfied by the sniffed packets.

17. The system of claim 11, wherein the one or more actions taken by the suspect code cause a first result and the one or more actions taken by the malicious code cause a second result, wherein the one or more actions taken by the suspect code are consistent with the one or more actions taken by the malicious code when the first result is equivalent to the second result.

18. The system of claim 17, wherein the first result is one or more of: an operating system setting is changed, an operating system feature is disabled, or a network connection is established.

19. A computer-readable memory device storing computer-executable instructions that, when executed by a computer processor, cause the computer processor to:
monitor execution of malicious code on an infected network node;
detect a control interaction between the infected network node and a first remote network node;
record, in a knowledge base, a behavioral model representative of one or more actions taken by the malicious code subsequent to the first network interaction;
monitor execution of suspect code on a protected network node;
record, in a communication log, information representative of a second network interaction between the protected network node and a second remote network node;
detect one or more actions taken by the suspect code consistent with the behavioral model; and
based on detecting the one or more actions taken by the suspect code:
(a) classify the protected network node as infected,
(b) add a network address for the second remote network node to a watch-list, and
(c) record, in the knowledge base, a traffic model based on the recorded information for the second network interaction.

20. The computer-readable memory device of claim 19, further storing computer-executable instructions that, when executed by a computer processor, cause the computer processor to detect the control interaction between the infected network node and the first remote network node based on one or both of:
the control interaction satisfying a traffic model for a malicious network interaction; and
the first remote network node is identified in the watch-list.
